(19) United States
(12) Patent Application Publication
(10) Pub. No.: US 2021/0112784 A1
(43) Pub. Date: Apr. 22, 2021

(54) BEEHIVE

(71) Applicant: Aleksandr Ivanovych SOKOLENKO, Kirovogradskaia obl. (UA)

(72) Inventor: Aleksandr Ivanovych SOKOLENKO, Kirovogradskaia obl. (UA)

(21) Appl. No.: 16/975,147

(22) PCT Filed: Sep. 27, 2018
(86) PCT No.: PCT/UA2018/000107

§ 371 Date: Aug. 24, 2020

(30) Foreign Application Priority Data
Feb. 23, 2018 (UA) U 2018 01908

(51) Int. Cl. A01K 47/02; A01K 47/06

(52) U.S. Cl. CPC A01K 47/02; A01K 53/00; A01K 47/06

(57) ABSTRACT

The invention relates to beekeeping. The claimed beehive comprises a hive body (1) having side walls (2, 3), a front wall (4), a rear wall (5), a bottom (6), and internally mounted trapezoidal frames (7); a cover (8) having a ceiling (9); and at least one bee entrance (14) having a flight board (15), said bee entrance being arranged in the wall of the hive body (1). The hive body (1) of the hive comprises at least three compartments, wherein a first compartment (10) comprises frames (7) that are arranged vertically at the same level, with the longer trapezoid base facing upward; a second compartment (11) is arranged higher than the first compartment (10) and comprises the same arrangement of vertical frames (7); and a third compartment (12) comprises frames (7) arranged vertically at different heights which gradually increase from one to the next within the third compartment, with the longer trapezoid base facing upward; wherein the third compartment (12) is arranged between the first compartment (10) and the second compartment (11) such that the height at which the frames (7) are positioned therein increases from the first compartment to the second compartment. The invention provides integration between a bee colony cluster and food reserves at all developmental stages, while also improving honey quality.

The invention relates to the field of agriculture, and specifically, to beekeeping, and more specifically, to the design of beehives, which are used at all stages of the development of a bee colony, production of honey and other related honey products.

The following beehive designs are known for such purposes.

A long hive is known, the design of which can be found, in particular, at the following link: https://sites.google.com/site/ulibees/ulik/ukrainskij-ulej-lezak-na-20-ramok. Such hive has a body with side walls, front and rear walls, a bottom, and internally mounted frames, a cover having a ceiling and at least one bee entrance with a flight board located on the wall of the body. All walls of the beehive are straight. Frames are straight and come in two sizes. The hive should also have racks attached to the body to store additional tools and the entire set of frames.

The known design has the following disadvantages: development of the bee colony occurs in an unnatural horizontal direction, which does not meet the requirements of the biology of honey bees; cleaning of the entire section of the bottom, where the cluster of bees was located, during the spring audit, which complicates the completion thereof; to produce commercial-grade honey, the entire brood-nest should be sorted, which slows down the operation considerably; wintering inside the hive is problematic because the cluster of bees is unable to move in different directions, i.e., after reaching the ceiling, the bee cluster dies of starvation, while having supplies of food, but not being able to move sideways to access food reserves; in the winter, it is much more difficult to warm-up the cluster, and to access honey located toward the sides of the cluster of bees, they have to move sideways to feed on cold food, which is almost impossible at sub-zero temperatures, i.e., while having enough food, the bees cannot use it; the application of two sizes of frames makes it impossible to use them quickly and efficiently; the use of racks attached to the body causes the need to use additional facilities for storing them; making the walls of the hive straight leaves them unprotected from rain and reduces the operating period of the hive; the straight shape of the frames makes extracting them from the hive and shaking off bees uncomfortable and difficult.

A multiple-story hive is also known, the information about which can be found, in particular, at the following link: http://bee-home.ru/bdzhil-hytstvo-vulyk.html. Such hive has several bodies with side walls, front and rear walls, a bottom, and internally mounted frames, a cover having a ceiling, and at least one bee entrance with a flight board located on the wall of the body. Such bodies are stacked on top of each other. This leads to the following disadvantage of such hive: it complicates transition of the bees from one body to another, which causes interruption in the bee cluster of up to 50 mm, which is unacceptable for the cluster of bees, since during winter season, they cannot move to the body filled with honey and die (i.e., while having enough food, the bees cannot use it), and during summer, the integrity of the bee colony becomes affected, the queen is limited to only one body, and the other bodies are not sufficiently utilized. In addition, the multiple-story hive has disadvantages similar to those of the long hive, i.e., the need for cleaning the entire bottom section, where the bee cluster was located during the audit; obtaining commercial-grade honey from the upper bodies is almost impossible to perform independently, without an assistant or technical means for collecting honey; a possibility of losing the cluster of bees in the winter due to their inability to overcome a large interframe space (which sometimes reaches a critical size of 50 mm), even with sufficient food reserves; the application of two sizes of frames also makes it impossible to use them quickly and efficiently; additional storage space is needed to store the hive bodies; making the walls of the hive body straight and protected from rain, reduced operating period of the hive, as well as inconvenience and difficulty associated with removing frames from the hive and shaking off bees.

Several beehive designs with vertical frame arrangement inside the body and/or a trapezoidal cross-section of the body are also known. They are described, for example, in U.S. Pat. No. 32,769 published on Jul. 9, 1861; U.S. Pat. No. 4,349,927 published on Sep. 21, 1982; and U.S. Pat. No. 4,402,099 published Sep. 6,1983. According to these designs, a beehive has a body with side walls, front and rear walls, a bottom and internally mounted frames, a cover having a ceiling, and at least one bee entrance with a flight board located on the wall of the body. However, in all these designs, the hive does not provide a possibility of smooth lifting of the frames and the compartment with their elevated positioning, it does not allow increasing the efficiency of hive use, safekeeping and quality of the beebread, increasing the new frame restoration rate with raw beeswax and development of the bee colony, increasing the convenience of replacing a queen, as well as improving the quality of obtained honey.

The prototype is based on the beehive described in Application US20130273807 published on Oct. 17, 2013. The hive according to the prototype has a body with side walls, front and rear walls, a bottom and internally mounted frames, a cover having a ceiling, and at least one bee entrance with a flight board located on the wall of the body. In this case, the hive has trapezoidal frames placed in such a way that the longer trapezoidal base faces upward. The frames are located at the same level along the entire length of the body. Thus, the prototype hive has disadvantages described above and caused by the absence of a separate compartment with elevated positioning of the frames, and their gradual rise to the height of this compartment, which leads to a potential worsening in the beebread stability, insufficient new frame restoration rate with raw beeswax and the development of the bee colony, reduced level of convenience while replacing a queen, as well as insufficient quality of the obtained honey due to the presence of raw beeswax therein.

The objective of the invention is to create a beehive design, which ensures the integration of the cluster of bee colony and food reserves at all stages of its development, the vertical (natural) development of the bee colony, the economical use of the beehive, safekeeping and quality of beebread, an increase in the new frame restoration rate with raw beeswax and development of the bee colony, an improved convenience of replacing a queen (silent replacement), while improving the quality of honey obtained using such hive.

This objective is achieved by the fact that in the well-known beehive, which provides for a vertical development of the bee colony and comprises a hive body with side walls, front and rear walls, a bottom and internally mounted frames, a cover having a ceiling, and at least one bee entrance with a flight board located on the wall of the body, according to the invention, the frames are made trapezoidal, while the hive body contains at least one first compartment, in which the frames are arranged vertically at the same level with the longer trapezoid bases facing upward, and at least one second compartment, in which the frames are arranged vertically with the longer trapezoid bases facing upward at a level higher than that of the frames in the first compartment, and at least one third compartment, in which the frames are arranged vertically with the longer trapezoid bases facing upward at different heights, which increase gradually for each frame within the third compartment, while the third compartment is located between the first and second compartments, so that the height of the frames located therewithin increases from the first compartment to the second compartment.

In a preferred embodiment of the invention, the first compartment is formed by the bottom, ceiling, side wall, as well as front and rear walls of the hive body, located at an angle to form a trapezoidal cross-section of said compartment with the longer trapezoid base facing upward.

In yet another embodiment of the invention, the second compartment is formed by the front and rear walls of the hive body, located at an angle to form a trapezoidal cross-section of said compartment with the longer trapezoid base facing upward, and the bottom and ceiling located at a greater height relative to the bottom and ceiling of the first compartment.

In yet another embodiment of the invention, the third compartment is formed by the front and rear walls of the hive body, located at an angle to form a trapezoidal cross-section with the longer trapezoid base facing upward, and the bottom and ceiling, located at an angle in a way to form a connection with the corresponding bottoms and canopies of the first and second compartments.

In yet another embodiment of the invention, the distance between the bottom plate of the frame and the bottom of the first compartment is greater than the distance between the bottom plate of the frame and the bottom of the second compartment.

In yet another embodiment of the invention, the hive comprises a second compartment of the body located in the center thereof, and two first compartments located on either side of the first compartment and connected thereto by the third compartments.

In yet another embodiment, the first compartments of the body further comprise embedded trapezoidal diaphragms located inside said compartments with the longer trapezoid base facing upward and between the very last frame and the corresponding side wall of the body.

In yet another embodiment of the invention, each of the first housing compartments comprises a bee entrance with a flight board arranged on the front wall of the body.

In yet another embodiment of the invention, the second compartment of the body contains a ventilation opening arranged in the front and rear walls of the body.

In yet another preferred embodiment, the beehive comprises frames of the same size.

The following cause-and-effect relationship exists between the above set of essential features of the invention and the claimed technical result.

The formation of a compartment allowing for the vertical development of a bee colony within the hive body ensures a more natural development thereof according to the biology of honey bees. This possibility is also achieved by smooth lifting of the frames, which is made possible by internally dividing the body into a first compartment with a lower arrangement of the frames, and a second compartment with a higher arrangement of the frames, and combining them with a third compartment, in which the frame arrangement provides a smooth rise from the first to the second compartment. This also helps achieve the integration between the bee colony cluster and food reserves at all stages of its development.

Due to the inclined portion of the bottom (third compartment), the accumulation of dead bees only occurs in the lower portion of the bottom, which makes spring audit easier.

Furthermore, the existence of a compartment located higher (second compartment) compared to the first compartment located lower within the hive body allows obtaining commercial-grade honey in this compartment and quickly collecting frames completely filled with honey.

Furthermore, when utilizing the beehive, it was unexpectedly discovered that wintering proceeds successfully for bees due to the ability for the bee cluster to move in different directions, specifically: upward and upward and sideways toward the front wall of the hive, and then toward the back, and again upward throughout the entire wintering time. So, in the winter, the cluster of bees moves upward along the honey-filled frames, while warming-up and eating honey. In the solutions known from the prior art, including the prototype, in the winter, after having reached the ceiling and not finding honey above them, the bees die of starvation. The lack of honey in the upper section can be explained by the fact that the flow of warm air in such hives does not move sideways, and does not warm-up the frames completely filled with honey, which are located along the sides. In the proposed hive, the frames are removed from the first compartment in the fall, since the bees will not move to the frames of the third compartment completely filled with honey after reaching the ceiling in the winter, and therefore, will die of starvation. In the fall, while preparing a brood-nest for the winter, the frames are left in the third compartment, and part of the frames are left in the second compartment. This helps change the shape of the winter cluster of bees from oval to elongated oval in the plane perpendicular to the planes of the frames (due to the inclined bottom of the third compartment). The flow of warm air under the inclined ceiling of the third compartment helps warm-up honey contained in the side frames. After reaching the ceiling in the winter, the bees can move along the upper bar of the frame to a smaller part of the frame containing warmed-up honey (due to a small difference in heights between the frames), and not to the upper bar of the adjacent frame (and then moving down to the frame contents and cold honey, as in the solutions known from the prior art). After collecting honey from this small portion of the frame, the bees form a warm part of the brood-nest from the empty cells, which results in the accumulation of a number of bees in this location sufficient to explore the larger part of the frame. Thus, the bees move not only vertically upward (in the plane of the frame), but also toward the sides (from frame to frame), which is not possible when the frames are arranged on the same level (as in the solutions known from the prior art). Thus, a sufficient quantity of honey frames in the second and third compartments protects the bee colony from starvation in the winter.

Furthermore, no extra storage facilities and/or protection from damage by bee-moth are not needed to store the complete set of frames for the claimed beehive, since all the frames are located directly inside the hive, and the hive material along with bees themselves protect the frames from destruction. This helps increase the economic effect from utilizing the hive, considering that bee-moth can destroy the entire supply of dry frames (empty frames after all honey has been pumped out).

Furthermore, the beehive of the claimed design ensures stable quality and safekeeping of beebread, which is the main source of protein for bees. This is very important at the end of the winter, and especially in the beginning of spring development of bees. It is known that in a frame containing honey, brood and beebread, honey is located above the brood, then the brood, and below it—beebread. After examining the beehive of the proposed design in the spring, frames with beebread were found, which were actively used by the bees to produce the brood (selected for brood). Such activity is due to the quality of beebread. The brood was found on 6 frames within the hives.

Furthermore, the trapezoidal shape of the frames and their arrangement in all compartments of the hive body with the longer trapezoid base facing upward allows increasing the rate of restoring new frames with beeswax. This, in turn, helps increase the yield of beeswax, as well as the rate of replacement with new ones, which results in increased size of bees and their performance. The indicated increase in rate and yield is due to the fact that the frames are narrowed toward the bottom and are placed in the warmest place, where there is always food.

Furthermore, in the beehive of the claimed design, bee colonies gain strength extremely quickly, since the queen can freely move from frame to frame, and therefore, is never limited in terms of work. This means that the colony is constantly in the working condition, quickly gains strength and never swarms, which is the key factor in beekeeping and allows freeing up time to work with a swarm.

Furthermore, the claimed design provides improved conditions for a silent replacement of the queen, which leads to significant time savings. To maintain the queen quality, they are periodically (according to a schedule) replaced with the breeding ones.

Furthermore, in the claimed design of the beehive, bees place honey in the upper frames, which are free of beebread. This improves the quality of honey, in contrast to the beehive designs known from the prior art, and specifically, the long hives, where bees place honey in the same frame that contains beebread, which worsens the properties of honey.

Furthermore, due to the use of embedded diaphragms and formation of additional compartments within the hive body, the proposed design makes it possible to make the hive more compact and versatile. Such special places within the hive allow for placement of a feeder, chisel, brush, queen cells, caps and other tools necessary for inspection. This allows using such tools separately for each colony. Therefore, when using the claimed beehive as part of an apiary, the spread of diseases among bees can be significantly reduced. The above-specified places can also be conveniently used for conducting work related to queen breeding.

Due to the trapezoidal shape of the beehive body (hive intersection formed by the walls located at an angle), the walls and flight boards are always protected from moisture during a rainy season. This results in a several-time increase in the hive usage duration. In addition, the trapezoidal shape of the hive body and frames makes it easier to extract the latter from the hive for inspection and to shake off the bees from the frame. Furthermore, this improves the conditions for preparing the bee colony for wintering, which becomes quick and easy.

The fact that the distance between the bottom plate of the frame and the bottom of the first compartment is greater than the distance between the bottom plate of the frame and the bottom of the second compartment, enables different temperature conditions, which can be maintained simultaneously within the hive body (in different compartments). For example, the summer heat forces bees to fly out of the hive and be outside. In the proposed design, the first compartment of the hive body is cooler due to a larger space under the frame (between the bottom of the frame and the bottom of the hive body) compared to the second compartment, which makes it possible for bees to always stay inside the hive in the summer and easily maintain the required temperature conditions.

The use of the same size frames within the hive improves the convenience of handling the frames. In addition, the proposed beehive has no attachments or extra bodies, which should otherwise be moved for storage.

The claimed invention is illustrated by the following embodiment along with the drawings.

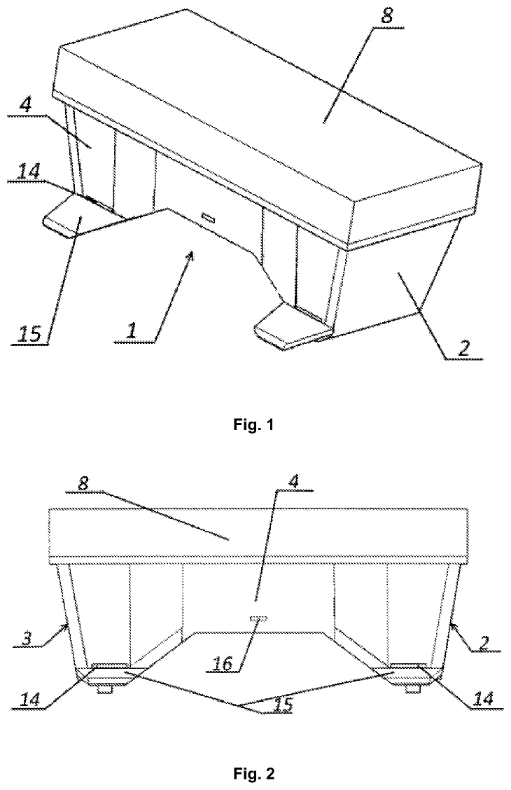

FIG. 1 shows a general view of the hive.

FIG. 2 shows a front view of the hive (with two bee entrances).

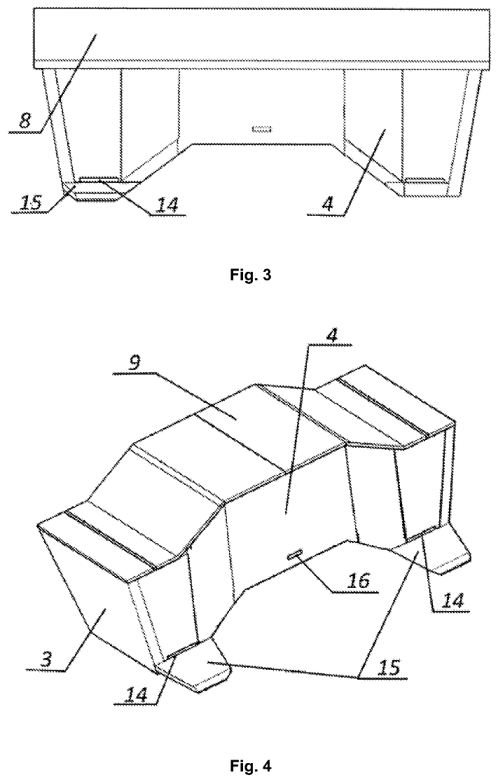

FIG. 3 shows a front view of the hive (with one bee entrance).

FIG. 4 shows a general view of the hive with the cover removed.

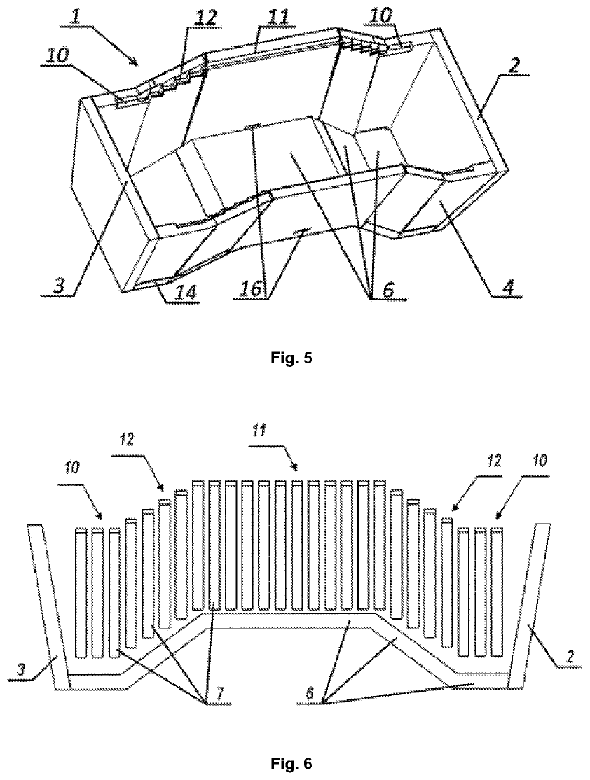

FIG. 5 shows a general view of the hive body with the cover and ceiling removed (without installed frames and flight boards).

FIG. 6 shows a schematic longitudinal section of the hive body illustrating the location of the frames (cover and ceiling not shown),

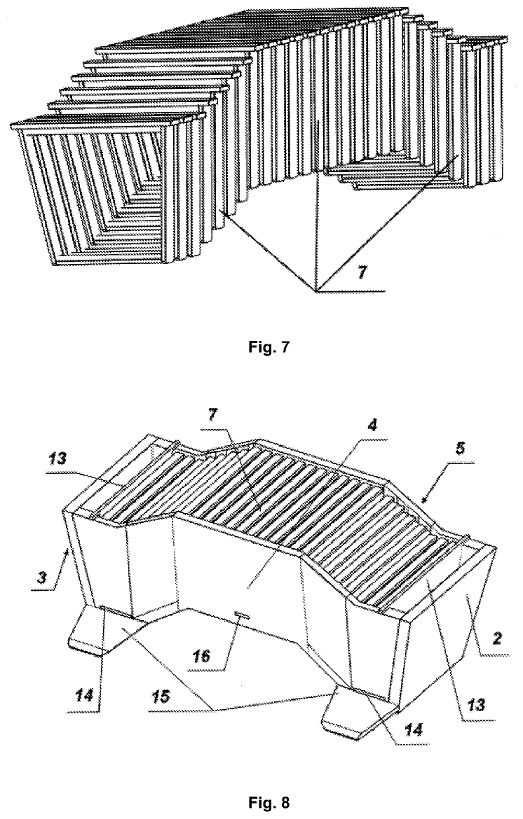

FIG. 7 shows a schematic axonometric view of the frame location inside the hive body (body not shown).

FIG. 8 shows a general view of the hive body with installed frames and removed cover and ceiling.

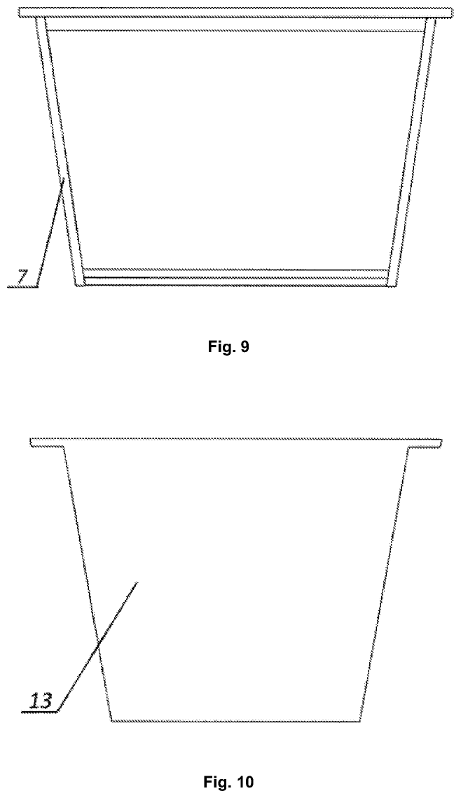

FIG. 9 shows a front view of the frame.

FIG. 10 shows a front view of the embedded diaphragm.

The provided example of the beehive design and drawings do not limit the embodiment options, and are intended for explanation purposes only.

A beehive, providing for a vertical development of a bee colony, comprises a hive body (1) with side walls (2) and (3), a front wall (4) and a rear wall (5), a bottom (6) and internally mounted frames (7), as well as a cover (8) having a ceiling (9). Frames (7) are trapezoidal and have the same size.

Hive body (1) comprises two first compartments (10) located on either side of the body (1). In each compartment (10), frames (7) are arranged vertically at the same level with the longer trapezoid bases facing upward. Each first compartment (10) is formed by bottom (6), ceiling (9), side wall (2), front wall (4), and rear wall (5) of the body (1). The front wall (4) and rear wall (5) of the body (1) are located at an angle relative to the vertical direction and, thus, form a trapezoidal cross-section of the compartment (10) with the longer trapezoid base facing upward.

Between compartments (10), in the central part of the body (1), there is a second compartment (11), in which frames (7) are located vertically at the same level with the longer trapezoid bases facing upward. Second compartment (11) is formed by front wall (4) and rear wall (5) of the body (1). Front wall (4) and rear wall (5) of the body (1) are located at an angle to form a trapezoidal cross-section of the compartment (11) with the longer trapezoid base facing upward. The level of arrangement of frames (7) within compartment (11) is higher than the level of frame arrangement in compartments (10). To achieve this, bottom (6) and ceiling (9) of compartment (11) are located at a higher level relative to the bottom (6) and ceiling (9) of each first compartment (10).

Compartments (10) and (11) are interconnected via third compartments (12). Each third compartment (12) is formed by front wall (4) and rear walls (5) of the body (1). Front wall (4) and rear wall (5) of the body (1) are arranged at an angle to form a trapezoidal cross-section of compartment (12) with the longer trapezoid base facing upward. Bottom (6) and ceiling (9) of compartment (12) are arranged at an angle and connected to the corresponding bottom (6) and ceiling (9) of the first (10) and second (11) compartments. In compartments (12), frames (7) are arranged vertically with the longer trapezoid base facing upward and at a different height, which increases gradually for each frame (7) within compartment (12). Each third compartment (12) is located between the first compartments (10) and second compartment (11) so that the height of frames (7) within the third compartment (12) increases from the first compartment (10) to the second compartment (11).

The distance between the lower plate of frame (7) and the bottom (6) of the first compartment (10) is greater than the distance between the lower plate of frame (7) and the bottom (6) of the second compartment (11) (FIG. 6).

First compartments (10) further comprise embedded diaphragms (13) having a trapezoidal shape and located inside said compartments (10) with the longer trapezoid bases facing up and between the very last frame (7) and the corresponding side walls (2) and (3) of the body (1).

Each of the first compartments (10) contains a bee entrance (14) with a flight board (15) (except for the hive shown in FIG. 3, in which one compartment (10) contains a bee entrance (14) with a flight board (15)). Bee entrance (14) with flight board (15) is arranged on the front wall of the body. The second compartment of the body (11) contains a ventilation opening (16) arranged in front wall (4) and rear wall (5) of the body (1).

The above-described beehive is utilized as follows.

After installing frames (7) in the necessary locations within the hive body (1), the bee colony is allowed to develop in the vertical direction. When utilizing the beehive, a feeder, chisel, brush, queen cells, caps and other tools necessary for inspection are placed within special locations formed between embedded diaphragms (13) and corresponding side walls (2) and (3) of the hive body (1). The specified locations within hive body (1) are also used to conduct work related to breeding queens. The complete set of frames (7) is stored directly within the hive body (1).

Thus, the claimed invention ensures the integration of the cluster of bee colony and food reserves at all stages of the development thereof, as well as vertical (natural) development of the bee colony, economical use of the hive, safekeeping and quality of the beebread, an increase in the rate of restoring new frames with raw beeswax and development of the bee colony, and increased convenience of queen replacement (silent replacement), while improving the quality of honey obtained by utilizing such hive.

1. A Sokolenko beehive, comprising a hive body with side walls, front and rear walls, a bottom and internally mounted frames, a cover having a ceiling, and at least one bee entrance with a flight board arranged on the body wall, characterized in that the frames are trapezoidal, and the hive body contains at least one first compartment, in which the frames are arranged vertically at the same level with the longer trapezoid base facing upward, at least one second compartment, in which the frames are arranged vertically with the longer trapezoid base facing upward and at the same level, which is higher than that of the frames in the first compartment, and at least one third compartment, in which the frames are arranged vertically with the longer trapezoid base facing upward and at a different height, which increases gradually for each frame within the third compartment, while said third compartment is located between the first and second compartments so that the height of the frames located therewithin increases from the first compartment to the second compartment.

2. The beehive according to claim 1, characterized in that the first compartment is formed by a bottom, a ceiling, a side wall and front and rear walls of the hive body, arranged at an angle to form a trapezoidal cross-section of said compartment with the longer trapezoid base facing upward.

3. The beehive according to claim 2, characterized in that the second compartment is formed by the front and rear walls of the hive body, arranged at an angle to form a trapezoidal cross-section of said compartment with the longer trapezoid base facing upward, wherein the bottom and the ceiling are located at a higher height relative to the bottom and the ceiling of the first compartment.

4. The beehive according to claims 2 and 3, characterized in that the third compartment is formed by the front and rear walls of the hive body, arranged at an angle to form a trapezoidal cross-section with the longer trapezoid base facing upward, wherein the bottom and the ceiling are arranged in a way to connect the corresponding bottoms and canopies of the first and second compartments.

5. The beehive according to claim 4, characterized in that the distance between the bottom plate of the frame and the bottom of the first compartment is greater than the distance between the bottom plate of the frame and the bottom of the second compartment.

6. The beehive according to claim 1, characterized in that said beehive contains a second compartment of the hive body located in the center thereof, and two first compartments located on either side of the first compartment and connected thereto by the third compartments.

7. The beehive according to claim 6, characterized in that the first compartments of the hive body further contain embedded trapezoidal diaphragms located within said compartments with the longer trapezoid base facing upward and between the very last frame and the corresponding side wall of the hive body.

8. The beehive according to claim 6, characterized in that each of the first housing compartments contains a bee entrance with a flight board arranged on the front wall of the hive body.

9. The beehive according to claim 6, characterized in that the second compartment of the hive body contains a ventilation opening arranged in the front and rear walls of the hive body.

10. The beehive according to claim 1, characterized in that said beehive contains frames of the same size.
